(19) United States
(12) Patent Application Publication
(10) Pub. No.: US 2006/0052902 A1
(43) Pub. Date: Mar. 9, 2006

(54) Method and system for SNCR optimization

(75) Inventors: Curt W. Lefebvre, Boston, MA (US); Daniel W. Kohn, Cambridge, MA (US)

Correspondence Address: WILMER CUTLER PICKERING HALE AND DORR LLP, 60 STATE STREET, BOSTON, MA, 02109, US

(73) Assignee: NeuCo, Inc., Boston, MA (US)

(21) Appl. No.: 11/211,418

(22) Filed: Aug. 25, 2005

Related U.S. Application Data
(60) Provisional application No. 60/605,409, filed on Aug. 27, 2004.

(51) Int. Cl. G05D 21/00

(52) U.S. Cl. 700/266

(57) ABSTRACT

A method and system are provided for controlling SNCR performance in a fossil fuel boiler. A performance goal for the boiler and data on current boiler performance is obtained. A determination is made as to whether the performance goal is satisfied by the current boiler performance. When the performance goal is not satisfied, the generally closest operating region in which the performance goal would be satisfied is identified. The operating region is associated with desired operating parameters of one or more devices affecting SNCR performance. One or more control moves are determined using the desired operating parameters of the one or more devices for directing the boiler to the operating region. The one or more control moves are communicated to the one or more devices.

### RELATED APPLICATION

This application is based on and claims priority from U.S. Provisional Patent Application Ser. No. 60/605,409 filed Aug. 27, 2004 and entitled Methods and Systems for SNCR Optimization, the specification of which is incorporated by referenced herein in its entirety.

### FIELD OF THE INVENTION

The present invention relates generally to fossil fuel boilers and, more particularly, to optimizing Selective Non-Catalytic Reduction (SNCR) performance in fossil fuel boilers.

### BACKGROUND OF THE INVENTION

The combustion of coal and other fossil fuels during the production of steam or power produces dozens of gaseous oxides, such as NO, NO₂, N₂O, H₂O, HO, O₂H, CO, CO₂, SO, SO₂, etc., which together, with N₂ and excess O₂, constitute the overwhelming majority of the boiler flue gas. Many of these species, such as OH and O₂H are highly reactive and are chemically quenched prior to the flue gas exit from the boiler stack. Some of the species, such as CO, CO₂, and H₂O are highly stable, the vast majority of which will pass unreacted out of the boiler stack. Still other species, such as SO₂, NO, and NO₂ are moderately reactive. These moderately reactive species are subject to removal from the flue gas by chemical reaction processes, and are also subject to complex variability.

NO and NO₂, together referred to as NOx, are gases that are highly toxic to humans. NOx can combine with H₂O to form nitric acid in the lungs and other mucosal membranes. In addition, NOx can react with O₂ in the lower troposphere to form ozone, also a toxic gas. For these and other reasons, including federal and state legislation, many industrial power plants seek to find ways to cost effectively reduce the flue gas NOx to acceptable emission levels.

NOx levels out of the furnace of industrial coal burning power plants vary, depending upon the particular combustion technology, typically from about 100 parts per million (ppm) to greater than one thousand ppm. NOx levels out of the furnace of industrial oil and gas burning power plants generally vary less because of the consistency of the fuel sources, from about 100 ppm to 600 ppm. Oil and gas combustion tend to produce lower levels of NOx than does coal combustion because there is little nitrogen found within oil or gas, and because they tend to burn at lower temperature than coal due to their relatively simple molecular structures. Desirable emission levels vary, depending upon many factors including plant location, stack height, furnace NOx levels, and state laws and provisions. Desirable emission levels may be expressed as an absolute number, e.g., less than 50 ppm, or as a percentage reduction from the furnace NOx levels. Desirable NOx emission levels can be as low as 10 ppm.

A number of technologies have been adapted by industrial power plants in order to reduce furnace NOx levels to acceptable emission levels. These include SNCR, Selective Catalytic Reduction (SCR), boiler optimization and tuning, the use of Over Fire Air (OFA) and other vertical staging of furnace air introduction techniques, and the use of low NOx burners. Each method has a typical NOx reduction range that tends to correlate well with the cost the market will bare for the device. The SNCR is capable of removing anywhere from about 35 to 90% of the flue gas NOx at comparatively moderate costs. Design and installation costs for industrial SNCRs can run about 10 million U.S. dollars. Annual operational costs, including reducing reagent and maintenance for an industrial SNCR can be in the hundreds of thousands of dollars.

An SNCR works by adding a reactive chemical reducing agent into the flue gas in appropriate stoichiometric amounts so that it may react with the NOx molecules and undergo a chemical reaction into harmless byproducts. The series of reactions is highly temperature dependent and typically reaches peak conversion efficiency at about 1700-1900 degrees Fahrenheit when using the two most common reducing agents.

SNCRs can use ammonia (NH₃) or urea (CO(NH₂)₂)) as the reducing reagent for reaction with NOx. Though there are many reactions that occur in the reduction of NOx into harmless byproducts, the total reaction equation for an SNCR that uses ammonia as the starting reagent can be generally expressed as:
NH₃+NO+¼O₂→1½ H₂O+N₂ (Equation 1)
While the reduction of NOx using urea as the starting reagent is a much more complex process, the total reaction equation is typically written as
CO(NH₂)₂+2NO+½O₂→CO₂+2H₂O+2N₂ (Equation 2)
Equation 1 indicates that ammonia and NO combine in a one to one ratio, and with oxygen in a 4 to 1 ratio, to produce water and nitrogen gas. This and other reaction mechanisms indicate the actual stoichiometric ratio of NOx and reducing reagent that get consumed by the reaction. Equation 2 indicates that urea and NO combine in a one to two ratio, and with oxygen in a one to one-half and two to one-half ratio respectively.

The actual amount of reducing potential that gets added to the flue gas is referred to as the Normalized Stoichiometric Ratio (NSR), and is given by the ratio of reactive chemical reducing moiety amount to NOx amount. For instance, if urea is added to the flue gas in a one to one stoichiometric ratio with NOx, then the NSR would be 2 because there are two reducing moieties in each molecule of urea, each of which can combine with an NO molecule to reduce it to N₂ and water.

In addition to the reactions expressed by Equations 1 and 2, many other chemical pathways exist for the reaction of the injected ammonia or urea, and are generally referred to as competing reactions. Many of these competing reactions also have strong nonlinear temperature dependence. The competing reactions prevent most practical SNCR applications from achieving greater than 30-60% NOx reduction. The competing reactions may also consume a large amount of the reducing reagent. For instance, an SNCR that removes 50% of the total flue gas NOx may require an NSR of 2. In this example, only ¼ of the original reducing reagent goes toward NOx reduction, and the remaining ¾ is consumed by competing reactions. Typical NSR values range from 0.5 to 3. Being able to control and optimize conditions towards minimizing the required NSR has significant impact on the reagent consumption and therefore on operating costs.

Competing reactions fall into many categories. Some actually include the formation of NOx by the high temperature oxidation of the urea nitrogen. Another competing reaction channel includes the formation of NH₃ from the urea that passes unreacted out of the high temperature region. The formation of unreacted ammonia is a small reaction channel in that it is responsible normally for the loss of a few ppm of reducing potential out of the many hundreds of ppm of reducing potential that are lost to competing reactions. However, the loss of ammonia from the reaction zone is a significant factor in the operation of an SNCR and therefore in its optimization.

Ammonia that is created in the SNCR but is not consumed in the high temperature region of the furnace or backpass is referred to as “slip”. The flue gas temperature decreases as it exits the furnace and heat is absorbed along the boiler walls. As the temperature decreases, low temperature reactions may occur with the ammonia, depending upon other flue gas constituents. These reactions include the formation of ammonium sulfates. Ammonium sulfates are very sticky, hard to manage molecules that tend to condense in the ductwork and require expensive cleaning efforts. Ammonia can also adhere to or be chemi-sorbed by fly ash, affecting its resale value. Also of concern is the amount of ammonia slip that makes it unreacted through all of the ductwork, as an emission from the stack. This quantity is of particular concern because ammonia has a noticeably pungent odor at 5 ppm and reaches dangerous human toxicity at 25 ppm.

SNCR manufacturers have developed numerous methods and devices that attempt to achieve the highest possible level of NOx removal, at the lowest NSR value, while maintaining acceptable ammonia slip levels. There are several challenges to matching the stoichiometry of the reagent and the NOx.

One challenge to SNCR optimization is to adjust the ammonia injection to the continuously varying distribution of NOx that comes out of the furnace. Levels of NOx can vary by a factor of two or more as measured laterally, front to back or left to right, across the duct. The distribution variations can happen rapidly and are a function of both exogenous (outside of the immediate operator or automatic control) and endogenous factors. Factors include load, combustion temperature, coal type, unit load, burner tilts, lateral fuel biases, lateral air biases, LOI, turbulence, coal particle size, vertical fuel bias, and vertical air bias, including OFA.

Rather than grapple with the problem of constantly matching the reagent injection profile to the NOx profile at all points along the two dimensions of lateral traversal across the duct, it is possible for an SNCR to use mixers to remove all lateral variations in the boiler NOx profile. Reducing reagent could then injected into the mixed flue gas and the combined gases then mixed again, to ensure the equal distribution of reagent. In practice, however, this method is not seen either with SNCRs that have been retrofit to older boilers or with SNCRs that are designed at the same time as the boiler. This method has a number of costs associated with it, including a thermodynamic efficiency cost related to the loss of exergy from the mixing process, material fatigue at the high temperatures required by an SNCR, and complication of furnace design. The injection of the reducing reagent into the SNCR provides for optimal conversion at high flue gas temperatures, around 1700-1900 degrees Fahrenheit, which is typical of gas just exiting the furnace and therefore keeps the net cost of this method high.

One way to manage the variability of the NOx left/right and front/back distribution is to enable the automated and real time manipulation of the reagent injection profile so that it can be adjusted to match the NOx distribution. A drawback to this method is that it requires the manipulation of multiple valves in a reagent injection grid (RIG). There is an installation expense to configuring multiple valves for actuation, an operational expense to enabling the real time manipulation of multiple RIG valves, and a further complication and associated hazard where the SNCR uses ammonia as the reducing reagent, of adding any movable part into an ammonia system. Many plants will deploy a real time automatic control of some subset of all possible controllable SNCR levers. Partial implementation saves cost and simplifies the optimization challenge.

Another way to manage the variability of the NOx distribution is to enable the manipulation of the reagent injection profile on a non-real time, periodic basis. In this method, the RIG profile is first tuned at commissioning of the SNCR and then again on some regular basis. The tuning procedure may include identification of the typical NOx distribution patterns from the boiler and subsequent adjustment of the RIG valves to achieve the desired stoichiometry. Typically, when using this method most valves are manually adjusted because automatic control actuation is not installed. The RIG valves are then fixed in this position until the next NOx distribution study is performed or until there is some other indication that a retuning is desired. There are numerous drawbacks to this methodology. First, the tuning is optimized for the typical, modal load (design) conditions of the boiler. At off-design loads the NOx distribution will change and will result in additional NOx or ammonia slip. Another drawback to this method is that it cannot compensate for the slow drifts that occur in the NOx distribution at the modal (and other) load over the period of a year. Another drawback to this method is that it cannot compensate for the variations that occur in furnace NOx distribution that result from different operator or automatic controllers that manipulate burner tilts, lateral fuel biases, lateral air biases, LOI, turbulence, coal particle size, vertical fuel bias, and vertical air bias, including OFA. In effect, this method is optimized for operation at the modal NOx distribution of the furnace and is sub-optimal at all other conditions.

The lateral furnace NOx profile can change as a function of air and fuel introduction parameters because NOx is created largely out of the Oxygen found in the air and Nitrogen found in the fuel. However, NOx profiles and, more importantly, integrated NOx quantities are strongly dependent upon the combustion temperature of the furnace and therefore upon the load of the unit. The very strong temperature dependence of NOx formation is a result of the usually exponential dependence of chemical reaction rates on temperature.

As a result, another challenge to SNCR optimization is to adjust the net reducing reagent injection amount into the flue gas as a function of combustion temperature. Because combustion temperature is expensive to measure continuously and reliably, most SNCRs do not use it as the sole input parameter for injected ammonia, but rather use unit load, a good proxy for combustion temperature, as the input parameter. Typically, design curves are used to represent the total furnace NOx production as a function of unit load. The load based NOx design curves are typically created during the commissioning of the SNCR and may be updated periodically over the life of the SNCR. The load based NOx curves are typically used by the DCS or other automated control system for the feed forward control of the total amount of injected ammonia. In particular, as unit load goes up, the feed forward control will anticipate the increased production of furnace NOx and will adjust the total ammonia injection levels accordingly. One drawback to feed forward control is that it does not make adjustments to the injected ammonia as a function of any variable except that which is specified in the curve. So, for instance, a large change in furnace NOx production resulting from a change in coal type would not result in a change in total ammonia injection. For this reason, most SNCR control systems that deploy a feed forward control loop also deploy a feed back control loop.

The feedback control loop of the SNCR is typically designed to measure the NOx slip (NOx level in the stack) and adjust the feed forward specified reagent injection amount so as to maintain a constant NOx slip or percentage NOx removal. The feedback loop can therefore correct for variations of total furnace NOx productions that differ from the load based design curves.

Another challenge to SNCR optimization is to adjust the net and laterally biased reducing reagent injection amount into the flue gas as a function of the backpass temperatures and the related rates of reaction efficiencies. This requirement is driven by the strong temperature dependence of the reactions indicated by Equations 1 and 2 and their competing reactions and makes accommodations for the fact that individual flow lines of flue gas act as adiabatic chemical reaction vessels, where very little chemical or physical mixing occurs between the constituents of different flow lines.

Industrial boilers of different design and fuel have a wide range of left/right and front/back furnace exit gas temperature variability. The variability results from anisotropies of combustion conditions within the furnace including burner location and spacing, burner tilt, fuel biasing, air biasing, furnace mixing, gas recirculation, cyclone conditions, fuel variability, etc.

Once in the backpass, heat transfer occurs by convection, or direct contact of hot flue gas with transfer surfaces. As a result, individual flue gas flow lines that differ in physical and chemical makeup as they exit the furnace will continue to change temperature in different ways as they progress along the backpass. Since the SNCR reagent injection also occurs at the top of the furnace or beginning of the backpass, the individual flue gas flow lines will also differ in reagent concentration and resulting chemical makeup.

As a result of the variations in physical and chemical attributes of the flow lines through the SNCR, certain flow lines will have greater or lesser integrated NOx reduction activity than the average. Assuming a certain distribution of NOx reduction activity, a reduction in average integrated activity will eventually lead to a critical level where complete reaction of the NOx and the ammonia no longer occurs along certain flow lines, resulting in both NOx and ammonia slip along those flow lines. This situation can be particularly difficult to manage because the standard SNCR feedback loops will see an increase in NOx slip and will correct for it by increasing the injected ammonia or urea, which will have the unintended affect of increasing ammonia slip.

### BRIEF SUMMARY OF EMBODIMENTS OF THE INVENTION

Briefly, in accordance with one or more embodiments of the invention, a method is provided for controlling SNCR performance in a fossil fuel boiler. The method features the steps of: obtaining a performance goal for the boiler; obtaining data on current boiler performance; determining whether the performance goal is satisfied by the current boiler performance; when the performance goal is not satisfied, identifying the generally closest operating region in which the performance goal would be satisfied, the operating region being associated with desired operating parameters of one or more devices affecting SNCR performance; determining one or more control moves using the desired operating parameters of the one or more devices for directing the boiler to the operating region; and communicating the one or more control moves to the one or more devices.

In accordance with one or more further embodiments of the invention, a system is provided for controlling SNCR performance in a fossil fuel boiler. The system includes: a controller input for receiving a performance goal for the boiler, and data on current boiler performance; a controller for determining whether the performance goal is satisfied by the current boiler performance, and when the performance goal is not satisfied, identifying the generally closest operating region in which the performance goal would be satisfied, the operating region being associated with desired operating parameters of one or more devices affecting SNCR performance, the controller also determining one or more control moves using the desired operating parameters of the one or more devices for directing the boiler to the operating region; and a controller output for communicating the one or more control moves to the one or more devices.

In accordance with one or more further embodiments of the invention, a computer program product is provided. The computer program product resides on a computer readable medium, for use in controlling SNCR performance in a fossil fuel boiler. The computer program product includes instructions for causing a computer to: receive a performance goal for the boiler; receive data on current boiler performance; determine whether the performance goal is satisfied by the current boiler performance; when the performance goal is not satisfied, identify the generally closest operating region in which the performance goal would be satisfied, the operating region being associated with desired operating parameters of one or more devices affecting SNCR performance; determine one or more control moves using the desired operating parameters of the one or more devices for directing the boiler to the operating region; and communicate the one or more control moves to the one or more devices.

These and other features will become readily apparent from the following detailed description wherein embodiments of the invention are shown and described by way of illustration. As will be realized, the invention is capable of other and different embodiments and its several details may be capable of modifications in various respects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

FIG. 1 is a schematic diagram of a fossil fuel boiler with an SNCR optimization system in accordance with one or more embodiments of the invention;

FIGS. 2A and 2B are flow charts illustrating a method for controlling SNCR performance in a fossil fuel boiler in accordance with one or more embodiments of the invention;

FIG. 3 is a schematic diagram of a fossil fuel boiler with an SNCR optimization system in accordance with one or more alternative embodiments of the invention;

FIGS. 4A and 4B are flow charts illustrating a method for controlling SNCR performance in accordance with one or more alternative embodiments of the invention; and

FIG. 5 is a schematic diagram of a fossil fuel boiler with an SNCR optimization system in accordance with one or more alternate embodiments of the invention.

In the drawings, like reference numbers are used to generally denote like parts.

### DETAILED DESCRIPTION OF THE PREFERRED EMBODIMENTS

The terms “optimal,” “optimize,” and “optimization” and the like as used herein refer generally to improving, e.g., efficiency, effectiveness or performance, and are not intended to require attaining ideal performance or any particular best value.

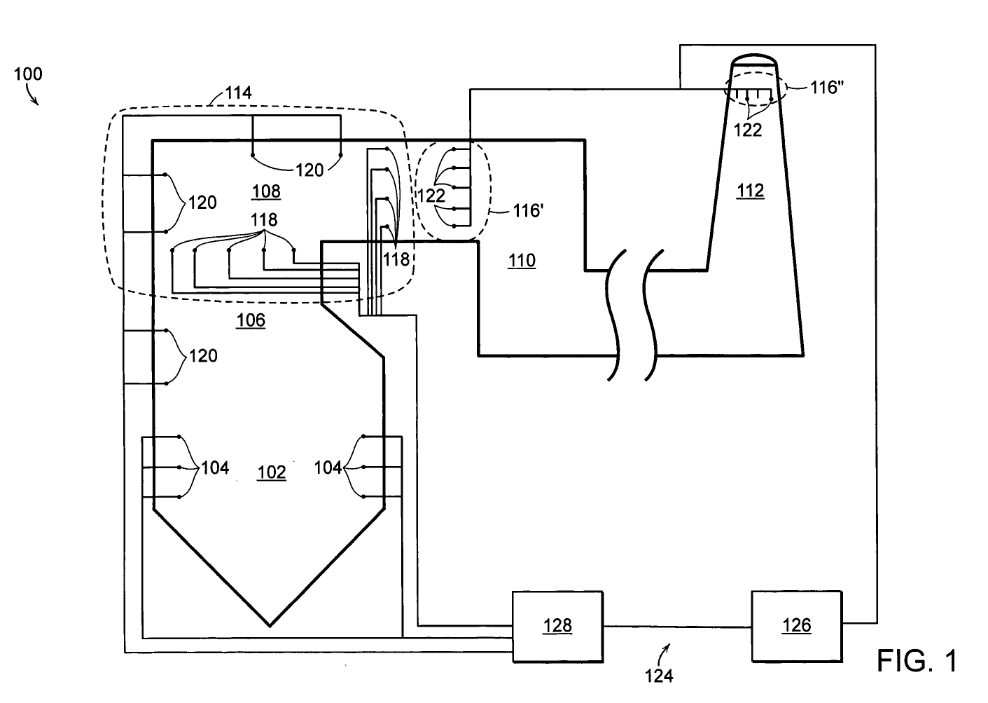

FIG. 1 schematically illustrates a fossil fuel boiler 100. The fossil fuel boiler 100 includes a combustion zone or furnace 102 for the combustion of fuel with air. The furnace 102 includes mechanisms and arrangements for the introduction of the fuel and air. These mechanisms can vary widely, and are indicated here generally by the fuel and air inlet controls 104. The furnace 102 leads to a first constriction 106 in the boiler. Beyond the constriction is a backpass 108, which is shown in FIG. 1 by a horizontal section and, proceeding from left to right, leading to a first descending section 110. The furnace and the backpass both contain heat transfer elements, such as metal tubing, containing heat transfer fluids that absorb radiant and convective heat from the hot combustion and post-combustion gases and circulates that heat to where it may be used to do work, such as turning a turbine. The circulation of those workable fluids and the resulting production of mechanical and electrical work is commonly referred to as the steam cycle and is not illustrated in FIG. 1. After leaving the backpass 108, the flue gas proceeds through the boiler ductwork towards a stack 112, which releases the gas into the atmosphere. Emissions control related devices, such as SCR, Flue Gas Desulfurization (FGD), Electro Static Precipitator (ESP), or other devices can be located between the backpass 108 and the stack 112. In some boiler designs, emission control devices may also be located in the furnace or the backpass. SNCR devices can be located in the backpass 108 and can take advantage of the high temperatures present in that area.

As illustrated in FIG. 1, in accordance with one or more embodiments of the invention, in order to optimize the efficiency and effectiveness of an SNCR (indicated generally at 114), a fossil fuel boiler 100 may be divided into one or more generally cross sectional slices or areas 116′, 116″ (116), each of which can separately be monitored for one or more of NOx, reducing reagent, and reaction rate profiles. In order to optimize the system to seek the generally maximal removal of NOx, the generally least generation of NH₃ slip, and the generally most cost effective use of reagent, any one of the generally cross sectional slices 116 can be associated with desirable NOx, reagent, and reaction rate profiles. In order to adjust the NOx profile at any cross sectional slice 116, the control system can adjust the fuel and air input controls 104. In order to adjust the reagent profile at any cross sectional slice 116 the control system may adjust the reagent injection controls 118. In order to adjust the reaction rate profile at any cross sectional slice 116, the control system may adjust the sootblowing controls 120. Sootblowing controls 120 operate furnace and backpass sootblowers, which are located in the vicinity of the SNCR and whose action controls the removal of soot from areas where heat transfer from the flue gas to the steam cycle impacts the temperature of the flue gas and correspondingly impacts the associated chemical reaction rates. Each cross sectional slice 116 also includes one or more sensors 122 that measure one or more properties indicative of the amount of and the distribution of NOx, NH₃, reagent, and reaction rate at that cross sectional slice 116. The data collected by the sensors 122 is useful both for timing control variable 104, 118, and 120 operations and for determining the effectiveness of those operations. The boiler 100 includes a NOx and NH₃ slip removal optimization system 124, with a controller 126 that configures one or more of the fuel/air and reagent injection, and soot blow control interfaces 128 in communication with fuel/air injectors 104, reagent injection grid 118, and sootblowers 120. The control interfaces 128 may include a Distributed Control System, DCS, with additional control logic directed towards the fuel/air injectors 104 and reagent injection grid 118, and sootblowers 120. The NOx and NH₃ slip removal and reagent use reduction optimization system 124 adjusts one or more of the fuel/air, reagent injection, and sootblowing operating parameters according to desired boiler performance goals using the controller 126. In the illustrated embodiment, controller 126 is a direct controller. As discussed below, in various embodiments, NOx and NH₃ slip removal and reagent use reduction optimization system 124 may include either a direct controller (i.e., one that does not use a system model) or an indirect controller (i.e., one that uses a system model). In embodiments in which the SNCR subsystem 124 incorporates a direct controller such as controller 126, it executes and optionally adapts (if it is adaptive) a control law that drives boiler 100 toward the boiler performance goals. Direct control schemes in various embodiments of the invention include, e.g., a table or database lookup of control variable settings as a function of the process state, and also include a variety of other systems, involving multiple algorithms, architectures, and adaptation methodologies. In accordance with one or more embodiments, a direct controller is implemented in a single phase.

In one or more embodiments, controller 126 may be a steady state or dynamic controller. A physical plant, such as boiler 100, is a dynamic system, namely, it is composed of materials that have response times due to applied mechanical, chemical, and other forces. Changes made to control variables or to the state of boiler 100 are, therefore, usually accompanied by oscillations or other movements that reflect the fast time-dependent nature and coupling of the variables. During steady state operation or control, boiler 100 reaches an equilibrium state such that a certain set or sets of control variable settings enable maintenance of a fixed and stable plant output of a variable such as megawatt power production. Typically, however, boiler 100 operates and is controlled in a dynamic mode. During dynamic operation or control, the boiler 100 is driven to achieve an output that differs from its current value. In certain embodiments, controller 126 is a dynamic controller. In general, dynamic controllers include information about the trajectory nature of the plant states and variables. In some embodiments, controller 126 may also be a steady-state controller used to control a dynamic operation, in which case the dynamic aspects of the plant are ignored in the control and there is a certain lag time expected for the plant to settle to steady state after the initial process control movements.

In accordance with one or more embodiments of the invention, three general classes of modeling methods can be used for the construction of direct controller 126. One method is a strictly deductive, or predefined, method. A strictly deductive method uses a deductive architecture and a deductive parameter set. Examples of deductive architectures that use deductive parameter sets include parametric models with preset parameters such as first principle or other system of equations. Other strictly deductive methods include preset control logic such as if-then-else statements, decision trees, or lookup tables whose logic, structure, and values do not change over time.

It is preferred that controller 126 be adaptive, to capture the off-design or time-varying nature of boiler 100. A parametric adaptive modeling method may also be used in various embodiments of the invention. In parametric adaptive modeling methods, the architecture of the model or controller is deductive and the parameters are adaptive, i.e., are capable of changing over time in order to suit the particular needs of the control system. Examples of parametric adaptive modeling methods that can be used in some embodiments of the invention include regressions and neural networks. Neural networks are contemplated to be particularly advantageous for use in complex nonlinear plants, such as boiler 100. Many varieties of neural networks, incorporating a variety of methods of adaptation, can be used in embodiments of the present invention.

A third type of modeling method, strictly non-parametric, that can also be used in embodiments of the invention uses an adaptive architecture and adaptive parameters. A strictly non-parametric method has no predefined architecture or sets of parameters or parameter values. One form of strictly non-parametric modeling suitable for use in embodiments of the invention is evolutionary (or genetic) programming. Evolutionary programming involves the use of genetic algorithms to adapt both the model architecture and its parameters. Evolutionary programming uses random, but successful, combinations of any set of mathematical or logical operations to describe the control laws of a process.

In embodiments in which controller 126 is adaptive, it is preferably implemented on-line, or in a fully automated fashion that does not require human intervention. The particular adaptation methods that are applied are, in part, dependent upon the architecture and types of parameters of the controller 126. The adaptation methods used in one or more embodiments of the invention can incorporate a variety of types of cost functions, including supervised cost functions, unsupervised cost function and reinforcement based cost functions. Supervised cost functions include explicit boiler output data in the cost function, resulting in a model that maps any set of boiler input and state variables to the corresponding boiler output. Unsupervised cost functions require that no plant output data be used within the cost function. Unsupervised adaptation is primarily for cluster or distribution analysis.

In accordance with one or more embodiments of the invention, a direct controller may be constructed and subsequently adapted using a reinforcement generator, which executes the logic from which the controller is constructed. Reinforcement adaptation does not utilize the same set of performance target variable data of supervised cost functions, but uses a highly restricted set of target variable data, such as ranges of what is desirable or what is bad for the performance of the boiler 100. Reinforcement adaptation involves training the controller on acceptable and unacceptable boiler operating conditions and boiler outputs. Reinforcement adaptation therefore enables controller 126 to map specific plant input data to satisfaction of specific goals for the operation of the boiler 100.

In accordance with one or more embodiments of the invention, a variety of search rules can be used that decide which of a large number of possible permutations should be calculated and compared to see if they result in an improved cost function output during training or adaptation of the model. In one or more embodiments, the search rule used may be a zero-order, first-order or second-order rule, including combinations thereof. It is preferred that the search rule be computationally efficient for the type of model being used and result in global optimization of the cost function, as opposed to mere local optimization. A zero-order search algorithm does not use derivative information and may be preferred when the search space is relatively small. One example of a zero-order search algorithm useful in embodiments of the invention is a genetic algorithm that applies genetic operators such as mutation and crossover to evolve best solutions from a population of available solutions. After each generation of genetic operator, the cost function may be reevaluated and the system investigated to determine whether optimization criteria have been met. While the genetic algorithms may be used as search rules to adapt any type of model parameters, they are typically used in evolutionary programming for non-parametric modeling.

A first-order search uses first-order model derivative information to move model parameter values in a concerted fashion towards the extrema by simply moving along the gradient or steepest portion of the cost function surface. First-order search algorithms are prone to rapid convergence towards local extrema and it is generally preferable to combine a first-order algorithm with other search methods to ensure a measure of global certainty. In some embodiments of the invention, first-order searching is used in neural network implementation. A second-order search algorithm utilizes zero, first, and second-order derivative information.

In accordance with one or more embodiments of the invention, controller 126 is generated in accordance with the control variables available for manipulation and the types of boiler performance objectives defined for boiler 100. Control variables can be directly manipulated in order to achieve the control objectives, e.g., reduce NOₓ output. As discussed above, in certain embodiments, the SNCR operating parameters are control variables that controller 126 manages directly in accordance with the overall boiler objectives. Significant performance parameters may include, e.g., emissions (NOₓ), heat rate, opacity, capacity, NH₃ slip minimization, and reagent consumption minimization. The heat rate or NOx output may be the primary performance factor that the SNCR optimization system 124 is designed to regulate. Desired objectives for the performance parameters may be entered into the controller 126, such as by an operator, or may be built into the controller 126. The desired objectives may include specific values, e.g., for emissions, or more general objectives, e.g., generally minimizing a particular performance parameter or maintaining a particular range for a parameter. Selecting values or general objectives for performance parameters, may be significantly easier initially than determining the corresponding SNCR operating settings for attaining those performance values. Desired values or objectives for performance parameters are generally known beforehand, and may be dictated by external requirements. For example, for the heat rate, a specific maximum acceptable level may be provided to controller 126, or controller 126 may be instructed to generally minimize the heat rate.

In exemplary embodiments, controller 126 is formed of a neural network, using a reinforcement generator to initially learn and subsequently adapt to the changing relationships between the control variables, in particular, the SNCR operating parameters, and the acceptable and unacceptable overall objectives for the boiler. The rules incorporated in the reinforcement generator may be defined by a human expert, for example. The reinforcement generator identifies the boiler conditions as favorable or unfavorable according to pre-specified rules, which include data values such as NOx emission thresholds, stack opacity thresholds, CO emission thresholds, current plant load, etc. For example, the reinforcement generator identifies a set of SNCR operating parameters as part of a vector that contains the favorable-unfavorable plant objective data, for a single point in time. This vector is provided by the reinforcement generator to controller 126 to be used as training data for the neural network. The training teaches the neural network to identify the relationship between any combination of SNCR operating parameters and corresponding favorable or unfavorable boiler conditions. In a preferred embodiment, controller 126 further includes an algorithm to identify the preferred values of SNCR operating parameters, given the current values of SNCR operating parameters, as well as a corresponding control sequence. In certain contemplated embodiments, the algorithm involves identifying the closest favorable boiler operating region to the current region and determining the specific adjustments to the SNCR operating parameters that are required to move boiler 100 to that operating region. Multiple step-wise SNCR operating parameter adjustments may be required to attain the closest favorable boiler objective region due to rules regarding SNCR operating parameter allowable step-size or other constraints.

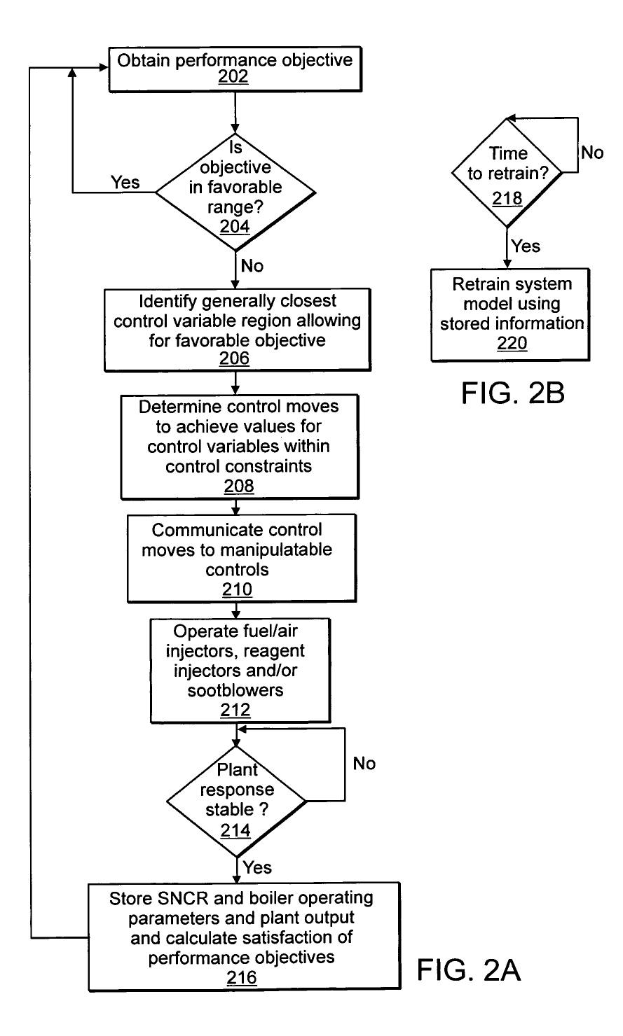

In accordance with one or more embodiments of the invention, a method for controlling SNCRs 114 and boiler fuel and air injection and sootblowing systems using controller 126 is shown in FIGS. 2A and 2B. In the initial step 202, controller 126 obtains a performance goal. For example, the goal may be to prioritize maintaining the NOx or NH₃ output of boiler 100 in a favorable range or to prioritize maintaining a generally minimal NOx or reagent variability across a particular cross sectional slice of the boiler. This may, e.g., be a cross sectional slice immediately following the last SNCR reagent injection port or a cross sectional slice within the boiler stack, immediately preceding emission of boiler effluent out of the stack. The selection of performance goal obtained in step 202 may also be influenced by the nature of the controller and control logic 128. In particular, control interfaces 128 may contain a DCS that contains both feed forward and feedback controls for reagent injection amount. If the feedback loop is to maintain a certain fixed stack NOx amount, then the controller 126 will not be able to effectively use a performance goal of stack NOx minimization. Under these conditions, the performance goal selection could be to generally minimize NOx cross sectional slice variability or to generally minimize NH₃ slip or NH₃ output variability or to generally minimize the cross sectional variability of the boiler NOx profile and the reagent injection profile, etc. In step 204, controller 126 checks the present NOx output or other present measured or calculated objective. If the objective is already favorable, controller 126 maintains the present control state or executes a control step from a previously determined control sequence until a new goal is received or the plant output is checked again. If the objective is not favorable, in step 206, controller 126 identifies the closest control variable region allowing for favorable objective. In one contemplated embodiment, the closest favorable boiler objective region is identified by an analysis of the boiler objective surface of the neural network of controller 126. The boiler objective surface is a function, in part, of the current boiler operating conditions. In certain embodiments, the algorithm sweeps out a circle of radius, r, about the point of current SNCR and boiler and sootblowing operating settings. The radius may be calculated as the square root of the quantity that is the sum of the squares of the distance between the current setting of each SNCR parameter value and the setting of the proposed SNCR parameter value. In particular,
Radius²=Σᵢ^{N} αᵢ(S.P²_{i-proposed}−S.P²_{i-current})²
for each i^{th} SNCR parameter, up to SNCR parameter number N, with normalization coefficients αᵢ. The sweep looks to identify a point on the boiler objective surface with a favorable value. If one is found in the first sweep, the radius is reduced, and the sweep repeated until the shortest distance (smallest radius) point has been identified. If a favorable plant objective surface point is not found upon the first sweep of radius r, then the radius is increased, and the sweep repeated until the shortest distance (radius) point has been identified. In one or more embodiments, multiple SNCR and boiler parameters may need to be adjusted simultaneously at the closest favorable control region. By way of example, the SNCR parameter values will include unit load and furnace temperature, vertical and horizontal fuel and air distribution settings that directly impact total furnace NOx and furnace NOx distributions; total reagent injection settings; reagent left/right and front/back bias settings; SNCR gas temperature; furnace and backpass wall cleanliness factors; sootblower activity; reaction rate distributions; etc.

In addition to identifying the closest control variable region that allows for satisfying the performance goal, controller 126 also determines a sequence of control moves in step 208. A number of control moves may be required because controller 126 may be subject to constraints on how many parameters can be changed at once, how quickly they can be changed, and how they can be changed in coordination with other parameters that are also adjusted simultaneously, for example. Other constraints may exist that limit the objective value of the performance goal, rather than limiting the rate at which controls may be moved to achieve the desired objective. For instance, if the performance goal is to generally minimize stack NOx, a constraint to limit the NH₃ slip should be built. This constraint would limit the amount and distribution of reagent injection and or NOx distribution so that the generally lowest stack NOx objective would be targeted that would be consistent with the specified NH₃ slip constraint. Controller 126 determines an initial control move. In step 210, it communicates that control move to the SNCR and boiler and sootblower manipulatable controls, e.g., through control interface 128. In step 212, fuel/air injection 104, reagent injection 118, and sootblowers 120 operate in accordance with the desired operating settings. After a suitable interval, indicated in step 214, preferably when the response to the fuel/air injection, reagent injection, and sootblowing operations are stable, the operating parameters and boiler outputs, i.e., indicators of actual boiler performance, are stored in step 216. Additionally, satisfaction of the performance goal is also measured and stored. In particular, the system may store information about whether the NOx level is satisfactory or has shown improvement. The control sequence is then repeated. In some embodiments, the identified SNCR and boiler and sootblower operating settings may not be reached because the performance goal or boiler operating conditions may change before the sequence of control moves selected by the controller for the previous performance goal can be implemented, initiating a new sequence of control moves for the SNCR and boiler and sootblower operations.

As shown in FIG. 2B, at steps 218 and 220, the stored SNCR and boiler and sootblower operating setting and boiler outputs, and the reinforcement generator's assessment of favorable and unfavorable conditions, are used on a periodic and settable basis, or as needed, as input to retrain controller 126. The regular retraining of controller 126 allows it to adjust to the changing relationship between the SNCR and boiler and sootblower parameters and the resulting boiler output values. In some embodiments of the invention, in place of controller 126 and sootblower interface 128, only a single controller is used to select the SNCR and boiler operating parameters and also operate the fuel/air injection 104, reagent injection 118, and sootblowing 120 according to those settings.

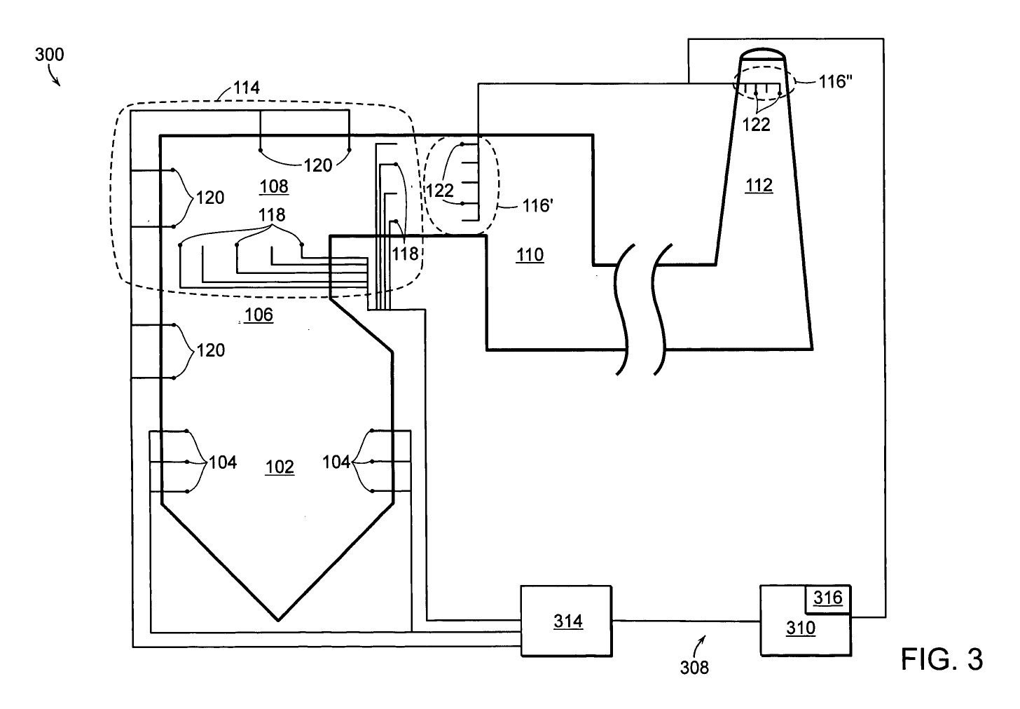

As illustrated in FIG. 3, one or more embodiments of the present invention may incorporate an alternative NOx and NH₃ slip and reagent consumption reduction optimization system 308 in a boiler 300. The NOx and NH₃ slip and reagent consumption reduction optimization system 308 includes a controller 310. In the illustrated embodiment, controller 310 is an indirect controller that uses a system model 316 to determine one or more of the sootblower, fuel and air injection, and reagent injection operating parameters that are required to achieve a desired performance level of boiler 100. Similar to controller 126, controller 310 optimizes one or more of the sootblowing, fuel and air injection, and reagent injection parameters to achieve and maintain the desired performance. In NOx and NH₃ slip and reagent consumption reduction optimization system 308, controller 310 also communicates the sootblower, fuel and air, and reagent injection operating settings to the sootblower, fuel and air, and reagent injection control interfaces 314. System model 316 is an internal representation of the plant response resulting from changes in its control and state variables with sootblower, fuel and air, and reagent injection operating parameters among the inputs, in addition to various state variables. In such embodiments, controller 310 learns to control the injection and cleaning processes by first identifying and constructing system model 316 and then defining control algorithms based upon the system model 316. System model 316 can represent a committee of models. In various embodiments of the invention incorporating an indirect controller, controller 310 may use any number of model architectures and adaptation methods. Various implementation techniques previously described in conjunction with controller 126 are also applicable to model 316. In general, model 316 predicts the performance of the boiler under different combinations of the control variables.

In various embodiments, system model 316 is a neural network, mass-energy balance model, genetic programming model, or other system model. Models can be developed using data about the actual performance of the boiler. For example, a neural network or genetic programming model can be trained using historical data about the operation of the boiler. A mass-energy balance model can be computed by applying first principles to historical or real-time data to generate equations that relate the performance of boiler to the state of boiler and the sootblower, fuel and air, and reagent injection operating parameters. Data that is collected during subsequent operation of the boiler 300 can later be used to re-tune system model 316 when desired.

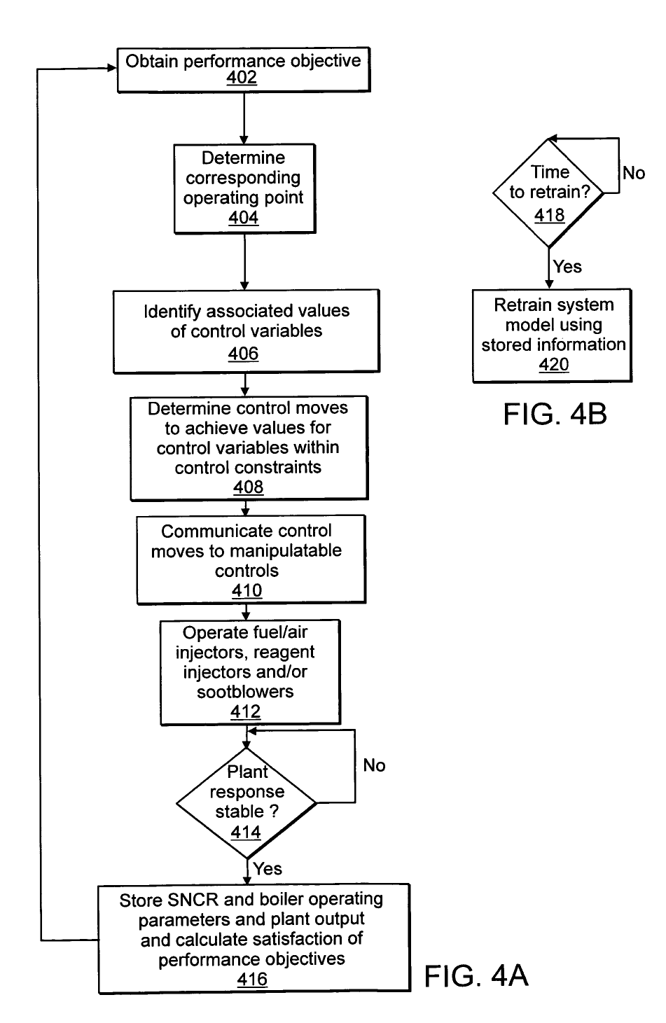

FIGS. 4A and 4B are flow diagrams illustrating an exemplary method for controlling SNCRs and boiler fuel and air injection and sootblower systems in accordance with one or more embodiments of the invention using an indirect controller such as controller 310. As shown in step 402, initially controller 310 receives a performance goal. In various embodiments, in step 404, controller 310 uses system model 316 to identify a point on the model surface corresponding to the current boiler state that meets the current boiler performance goal, e.g., minimizing NOx. In step 406, controller 310 uses system model 316 to identify the boiler inputs, such as the sootblower, fuel and air, and reagent injection operating parameters, corresponding to that point that will generate the desired boiler outputs. In step 408, controller 310 determines control moves to achieve values for control variables within control constraints as with controller 126. In step 410, controller 310 communicates the sootblower, fuel and air, and reagent injection operating settings for the initial step to sootblower, fuel and air, and reagent injection control interfaces 314. In step 412, sootblowers, fuel and air injectors, and reagent injectors operate in accordance with the sootblower, fuel and air, and reagent injection operating settings.

After a suitable interval, preferably after the plant response is determined to be stable at 414, as shown in step 416, the sootblower, fuel and air, and reagent injection operating parameters and plant outputs, such as the NOx output, are stored. The control cycle is repeated after suitable intervals.

As shown in FIG. 4B, at step 418, from time to time, controller 314 and/or model 316 are determined to require retraining. Accordingly, system model 316 is retrained using the information stored in step 416.

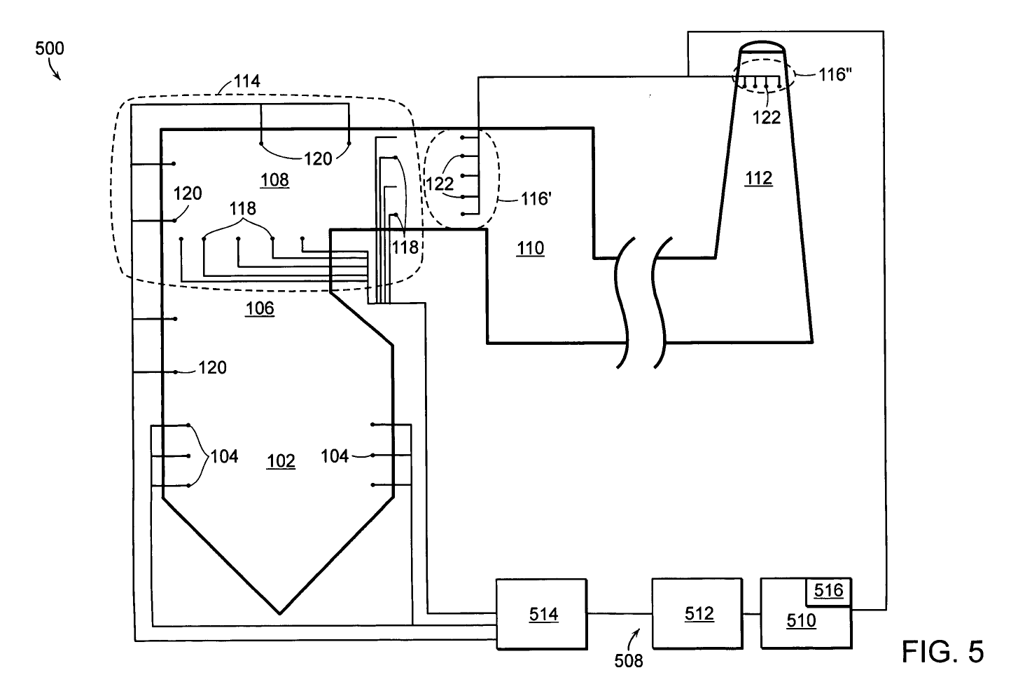

In an alternate embodiment, a boiler 500 shown in FIG. 5 includes an optimization system 508. The system 508 includes an indirect controller 510, which uses a system model 516 to determine a set of NOx profiles, reagent profiles, and reaction rate profiles for the set of cross sectional slices 116 in the boiler 500 that are required to achieve or approximate as closely as possible a desired performance level of the boiler. In alternate embodiments, controller 510 can be a direct controller that determines the set of NOx, reagent, and reaction rate profiles. In either type of embodiment, NOx, reagent, and reaction rate profiles are determined as functions of the boiler performance goals, which are generally known or readily definable. In one embodiment, controller 510 uses system model 516 to evaluate the effects of different sets of reaction rate, NOx, and reagent profiles under the current boiler operating conditions and determine one or more sets of reaction rate, NOx, and reagent profiles that will satisfy the desired performance objective. Controller 510 receives as input the current boiler state, including the current reaction rate, NOx, and reagent profiles, and desired performance goals. As discussed above, boiler operating conditions generally include fuel/air mixtures, feed rates, the type of fuel used, reagent injection distribution, reagent total injection, sootblowing activity, etc. As illustrated in FIG. 5, the controller 510 is in communication with a processor 512 that optimizes sootblower, reagent injection, and fuel and air injection operating parameters to maintain given reaction rate, reagent, and NOx profiles. Controller 510 transmits sets of reaction rate, reagent, and NOx profiles to processor 512. Processor 512 optimizes the sootblower, reagent injection, and fuel and air injection operating parameters to maintain the received profiles. Processor 512 in turn is in communication with a sootblower, reagent injector, and fuel and air injector control interfaces 514 and transmits the desired sootblower, reagent injection, and fuel and air injection operating parameters to the control interfaces 514 as necessary.

As illustrated, a single controller 126, 310, or 510 or processor 512 may handle all of the cross sectional slices 116 in the boiler. Alternatively, multiple controllers or processors may be provided to handle all of the cross sectional slices 116 in the boiler.

In another embodiment of the invention, processor 512 is an indirect controller that incorporates a system model that relates the sootblower, reagent injector, and fuel and air injector operating parameters to the reaction rate, NOx, and reagent profiles in cross sectional slices 116. Processor 512 uses a process similar to the process shown in FIG. 4 to determine a set of sootblower, reagent injector, and fuel and air injector operating settings from a received set of desired reaction rate, NOx, and reagent profiles using a system model. Processor 512 receives as inputs the current boiler operating conditions, including the current sootblower state and activity, and reaction rate, NOx, and reagent profiles measured by sensors 106, as well as the set of desired reaction rate, NOx, and reagent profiles. The set of desired profiles provide the performance goal for the processor 512. Using the system model, processor 512 identifies the corresponding operating point and then selects one or more control moves to attain the desired operating point. The system model incorporated in processor 512 can be retrained periodically or as needed. The system model can also be represented as a committee of models.

In some embodiments of the invention, a single controller, as that described heretofore as controller 126, may be integrated with processor 512 and control interface 514. In this integrated embodiment, the controller may compute desired reaction rate, NOx, and reagent profiles and sootblower, reagent injection, and fuel and air injection operating parameters expected to attain those reaction rates, NOx, and reagent profiles. In another embodiment of the invention, a single indirect controller may result from the integration of the function of processor 512 and control interface 514. In this integrated embodiment, the indirect controller will compute and control the sootblower, reagent injection, and fuel and air injection parameters necessary to attain the desired reaction rates, NOx, and reagent profiles specified by the output of controller 510.

The controllers in the illustrated embodiments of the invention are, preferably, implemented in software and run the models also, preferably, implemented in software to perform the computations described herein, operable on a computer. The exact software is not a critical feature of the invention and one of ordinary skill in the art will be able to write various programs to perform these functions. The computer may include, e.g., data storage capacity, output devices, such as data ports, printers and monitors, and input devices, such as keyboards, and data ports. The computer may also include access to a database of historical information about the operation of the boiler. The processor 512 is preferably a similar computer designed to perform the processor computations described herein.

As referenced above, various components of the SNCR optimization system could be integrated. For example, the sootblower, reagent injector, and fuel and air injector control interfaces 514, the processor 512, and the model-based controller 510 could be integrated into a single computer; alternatively model-based controller 310 and sootblower, reagent injector, and fuel and air injector interfaces 114 could be integrated into a single computer. The controllers 126, 310 or 510 may include an override or switching mechanism so that efficiency set points or sootblower, reagent injector, or fuel and air injector optimization parameters can be set directly, for example, by an operator, rather than by the model-based controller when desired.

While the present invention has been illustrated and described with reference to preferred embodiments thereof, it will be apparent to those skilled in the art that modifications can be made and the invention can be practiced in other environments without departing from the spirit and scope of the invention.

1. A method for controlling SNCR performance in a fossil fuel boiler, comprising the steps of:
(a) obtaining a performance goal for the boiler;
(b) obtaining data on current boiler performance;
(c) determining whether the performance goal is satisfied by the current boiler performance;
(d) when the performance goal is not satisfied, identifying the generally closest operating region in which the performance goal would be satisfied, the operating region being associated with desired operating parameters of one or more devices affecting SNCR performance;
(e) determining one or more control moves using the desired operating parameters of said one or more devices for directing the boiler to the operating region; and
(f) communicating the one or more control moves to said one or more devices.

2. The method of claim 1 wherein said one or more devices include one or more of: reagent injectors for controlling reagent profiles in one or more generally cross-sectional areas of said boiler, sootblowers for controlling reaction rate profiles in one or more generally cross-sectional areas of said boiler, and fuel and air injectors for controlling NOₓ profiles in one or more generally cross-sectional areas of said boiler.

3. The method of claim 2 wherein said reagent comprises ammonia or urea.

4. The method of claim 1 wherein the performance goal for the boiler comprises maintaining NOₓ or reagent output of the plant in a favorable range.

5. The method of claim 1 wherein the performance goal for the boiler comprises maintaining NOₓ or reagent variability across a given generally cross-sectional area of the boiler in a favorable range.

6. The method of claim 1 further comprising periodically repeating steps (a) to (f).

7. The method of claim 1 wherein steps (c), (d) and (e) are performed using a direct controller.

8. The method of claim 1 wherein steps (c), (d) and (e) are performed using an indirect controller with a system model that relates operating parameters of the one or more devices to the boiler performance parameters.

9. The method of claim 8 wherein said system model is a neural network.

10. The method of claim 8 wherein said system model is a mass-energy balance model.

11. The method of claim 8 wherein said system model is a genetically programmed model.

12. The method of claim 8 further comprising the step of storing information about the one or more control moves and corresponding measured boiler performance values and retraining the system model using the stored information.

13. A system for controlling SNCR performance in a fossil fuel boiler, comprising:
a controller input for receiving a performance goal for the boiler, and data on current boiler performance;
a controller for determining whether the performance goal is satisfied by the current boiler performance, and when the performance goal is not satisfied, identifying the generally closest operating region in which the performance goal would be satisfied, the operating region being associated with desired operating parameters of one or more devices affecting SNCR performance, said controller also determining one or more control moves using the desired operating parameters of said one or more devices for directing the boiler to the operating region; and
a controller output for communicating the one or more control moves to said one or more devices.

14. The system of claim 13 wherein said one or more devices include one or more of: reagent injectors for controlling reagent profiles in one or more generally cross-sectional areas of said boiler, sootblowers for controlling reaction rate profiles in one or more generally cross-sectional areas of said boiler, and fuel and air injectors for controlling NOₓ profiles in one or more generally cross-sectional areas of said boiler.

15. The method of claim 14 wherein said reagent comprises ammonia or urea.

16. The system of claim 13 wherein the performance goal for the boiler comprises maintaining NOₓ or reagent output of the plant in a favorable range.

17. The system of claim 13 wherein the performance goal for the boiler comprises maintaining NOₓ or reagent variability across a given generally cross-sectional area of the boiler in a favorable range.

18. The system of claim 13 wherein said controller is a direct controller.

19. The system of claim 13 wherein said controller is an indirect controller with a system model that relates operating parameters of the one or more devices to the boiler performance parameters.

20. The system of claim 19 wherein said system model is a neural network.

21. The system of claim 19 wherein said system model is a mass-energy balance model.

22. The system of claim 19 wherein said system model is a genetically programmed model.

23. The system of claim 19 further comprising a storage for storing information about the one or more control moves and corresponding measured boiler performance values, and wherein the system model is retrained using the stored information.

24. A computer program product, residing on a computer readable medium, for use in controlling SNCR performance in a fossil fuel boiler, the computer program product comprising instructions for causing a computer to:
receive a performance goal for the boiler;
receive data on current boiler performance;
determine whether the performance goal is satisfied by the current boiler performance;
when the performance goal is not satisfied, identify the generally closest operating region in which the performance goal would be satisfied, the operating region being associated with desired operating parameters of one or more devices affecting SNCR performance;
determine one or more control moves using the desired operating parameters of said one or more devices for directing the boiler to the operating region; and
communicate the one or more control moves to said one or more devices.

25. The computer program product of claim 24 wherein said one or more devices include one or more of: reagent injectors for controlling reagent profiles in one or more generally cross-sectional areas of said boiler, sootblowers for controlling reaction rate profiles in one or more generally cross-sectional areas of said boiler, and fuel and air injectors for controlling NOₓ profiles in one or more generally cross-sectional areas of said boiler.

26. The computer program product of claim 25 wherein said reagent comprises ammonia or urea.

27. The computer program product of claim 24 wherein the performance goal for the boiler comprises maintaining NOₓ or reagent output of the plant in a favorable range.

28. The computer program product of claim 24 wherein the performance goal for the boiler comprises maintaining NOₓ or reagent variability across a given generally cross-sectional area of the boiler in a favorable range.

29. The computer program product of claim 24 wherein the computer program product defines a direct controller.

30. The computer program product of claim 24 wherein the computer program product defines an indirect controller with a system model that relates operating parameters of the one or more devices to the boiler performance parameters.

31. The computer program product of claim 30 wherein said system model is a neural network.

32. The computer program product of claim 30 wherein said system model is a mass-energy balance model.

33. The computer program product of claim 30 wherein said system model is a genetically programmed model.

34. The computer program product of claim 30 further comprising instructions for causing the computer to store information about the one or more control moves and corresponding measured boiler performance values and retrain the system model using the stored information.
